(19) United States
(12) Patent Application Publication
(10) Pub. No.: US 2013/0014751 A1
(43) Pub. Date: Jan. 17, 2013

(54) HELMET-MOUNTED RESPIRATOR APPARATUS WITH A DUAL PLENUM SYSTEM

(71) Applicant: David L. Ausen, Eagan, MN (US)

(72) Inventor: David L. Ausen, Eagan, MN (US)

(73) Assignee: 3M Innovative Properties Company

(21) Appl. No.: 13/635,932

(22) PCT Filed: Mar. 30, 2011
(86) PCT No.: PCT/US2011/030518

§ 371 Date: Sep. 19, 2012

Related U.S. Application Data
(60) Provisional application No. 61/321,359, filed on Apr. 6, 2010.

(51) Int. Cl. A62B 18/00

(52) U.S. Cl. 128/201.24; 29/428

(57) ABSTRACT

Powered air respirators include a helmet, a filtering assembly within the helmet, and a face shield assembly pivotably attached to and depending from the front of the helmet mid in fluid communication with the filtering assembly by a filtered-air passageway. The filtering assembly includes a blower assembly including an filtered-air outlet and an inlet, the filtered-air outlet being in fluid communication with the filtered-air passageway, a filtered-air plenum chamber in fluid communication with the inlet of the blower assembly, a filter member adjacent to, and in fluid communication with the filtered-air plenum chamber, and a contaminated-air plenum chamber adjacent to, and in fluid communication with the filter member and in fluid communication with a contaminated-air inlet.

### FIELD OF THE DISCLOSURE

The present disclosure pertains to powered air filtration devices, especially helmet-mounted respirator devices.

### BACKGROUND

Supplied air respirators are regularly worn in environments where the surrounding air contains or may contain contaminants. Clean air is delivered to the wearer from a supply tank or from a powered air source that draws or drives the ambient air through an air filter.

Systems that use a powered air source to supply clean air to the wearer are referred to as powered air purifying respirators, or “PAPRs”. PAPRs may come in a variety of types, but two common types are belt pack PAPRs and helmet PAPRs. Belt pack PAPRs typically have two main parts: a facepiece and a filtering unit. The facepiece is worn at least over the nose and mouth of the user (it also may cover the eyes and ears), and the filtering unit is worn about the user's waist. Typically a hose connects the filtering unit to the facepiece. Helmet PAPRs typically include a pivotal visor as a facepiece and a filtering unit contained within or attached to the helmet.

In both types of PAPRs, the filtering unit often includes one or more filter cartridges, a housing, a fan, and an electric motor that drives the fan. The fan and motor are contained within the housing, and the filter cartridges are attached to the housing body. Ambient air is filtered by being forced or drawn through filter elements that are contained within the filter cartridges. The electrically powered fan drives or draws the air through the filter cartridges, through the hose, and into the facepiece interior. Because the fan does the work required for air movement through the PAPR system, the user is able to comfortably receive a clean supply of air with little effort.

Each style of PAPR has advantages and disadvantages. The belt pack style can be easier for a user to wear because the weight of the filtering unit is carried on the waist and not the head. However, having a two piece system can be cumbersome and the connecting hose is yet another component that needs to be manufactured and assembled and can suffer from the typical drawbacks of such connecting members. The helmet style PAPR avoids these drawbacks by being a single self-contained unit, but the weight of the filtering unit can be uncomfortable especially when worn for long periods of time.

### SUMMARY

Disclosed herein are powered air respirators typically comprising a helmet, a filtering assembly within the helmet, and a face shield assembly adapted to be positioned in the front of the helmet and in fluid communication with the filtering assembly by a filtered-air passageway. In some embodiments, the face shield assembly is pivotably attached to and depending from the front of the helmet. The filtering assembly generally comprises a blower assembly including a filtered-air outlet and an inlet, the filtered-air outlet being in fluid communication with the filtered-air passageway, a filtered-air plenum chamber in fluid communication with the inlet of the blower assembly, a filter member adjacent to, and in fluid communication with the filtered-air plenum chamber, and a contaminated-air plenum chamber adjacent to, and in fluid communication with the filter member and in fluid communication with a contaminated-air inlet.

### BRIEF DESCRIPTION OF THE DRAWINGS

The disclosure may be more completely understood in consideration of the following detailed description of various embodiments of the disclosure in connection with the accompanying drawings.

FIG. 1 shows a side cut away view of a helmet mounted powered air purifying respirator of this disclosure.

FIG. 2 shows a cut away view of the flow of air within a helmet mounted powered air purifying respirator of this disclosure.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure provides a powered, portable air filtering device for a helmet-mounted powered air purifying respirator or PAPR. The helmet-mounted PAPR is designed to be worn by a user to supply purified air to the user. Air filtering devices are regularly used in environments where the surrounding air contains contaminants or may potentially contain contaminants. Such contaminants include, for example, fumes, gases, particulates, vapors and the like which may be present alone or in combination.

While traditional helmet-mounted PAPRs have many desirable features, they also have the drawbacks of increasing the size and weight of the helmet, making them uncomfortable and cumbersome for the user. Additionally, depending upon the location of the components of the helmet-mounted PAPR within the helmet, the traditional helmet can be unbalanced, i.e. having greater weight in certain points, which can cause the helmet to become improperly positioned, or can place a strain upon the user's neck and/or back. The powered, portable air filtering device of the present disclosure, however, comprises a dual plenum system to make the air filtering device more compact. The more compact systems, or “low profile systems” of this disclosure offer the user better comfort and are less cumbersome and therefore are less likely to interfere with the performance of tasks performed by the user. This compactness is achieved without sacrificing air delivery performance.

Besides having a lower profile, the powered, portable air filtering device of the present disclosure has additional design advantages. The dual plenum system design permits the contaminated air to be drawn through the filter media instead of being forced through the filter media. This allows the contaminated air to be filtered before entering the blower apparatus. This design keeps the contaminated air from contacting the blower apparatus and possibly causing damage or increasing the wear and tear to the components of the blower apparatus. Also, the dual plenum design permits a larger surface of the filter media to be exposed to the contaminated air.

As used herein, the term “powered air purifying respirator or PAPR” means a supplied air respirator that uses a power source to deliver filtered air to breathing headgear.

As used herein, the terms “filtered air” and “filtered-air” means air (or other oxygen-containing gas) that has been filtered by any suitable filtering apparatus. Typically, “filtered-air” is hyphenated when used as an adjective to describe an assembly such as, for example, a “filtered-air chamber” but when used as a noun, “filtered air” is not hyphenated.

As used herein the terms “contaminated air” and “contaminated-air” mean air (or other oxygen-containing gas) that has not been filtered and may contain one or more contaminants. Typically, “contaminated-air” is hyphenated when used as an adjective to describe an assembly such as, for example, a “contaminated-air inlet” but when used as a noun, “contaminated air” is not hyphenated.

As used herein, the term “breathing head gear” means an apparatus to which purified air is supplied that is worn by a person, such breathing head gear includes for example facepieces which fit snugly over at least the respiratory passages (nose and mouth) of a person, as well as loose fitting facepieces such as, for example, face shield assemblies pivotably attached to and depending from the front of a helmet.

As used herein, the term “filter bed” means a structure that includes a filter element and that is adapted for connection to or use in a filtering unit, a “curved filter bed” is one that is not planar but has a radius of curvature; generally the curved filter bed is continuous over the length of curvature, i.e. it is not subdivided along the length of curvature into different filter modules; typically the filter bed includes adsorbent particles.

As used herein, the term “filter cartridge” means a structure that includes a filter element and that is adapted for connection to or use in a filtering unit, a “curved filter cartridge” is one that is not planar but has a radius of curvature.

As used herein, the term “filtering unit” means the portion of a PAPR that is responsible for filtering ambient air and causing powered air movement.

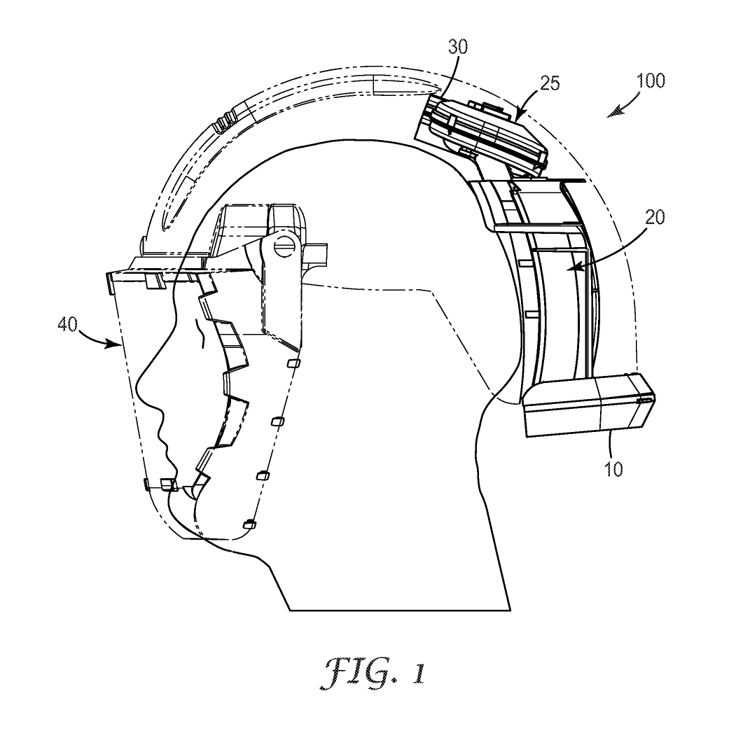

FIG. 1 shows a side view of a helmet mounted PAPR 100. PAPR 100 comprises a motorized system, in which contaminated air enters the PAPR through contaminated air inlet 10, passes through the filter assembly 20, passes into blower assembly 25, and exits blower assembly 25 via filtered-air outlet 30. Filtered-air outlet 30 is in fluid communication with face shield assembly 40.

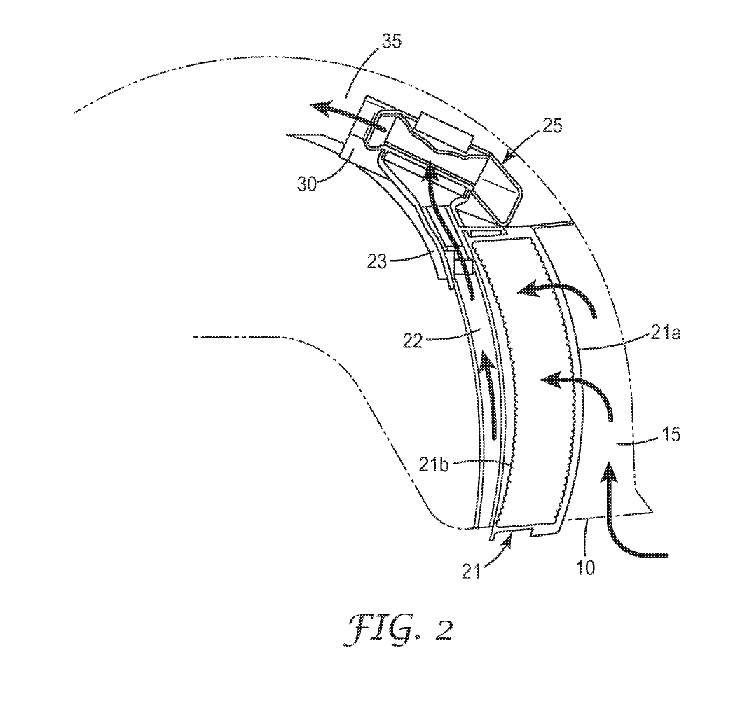

FIG. 2 further illustrates the flow of air in the helmet mounted PAPR of FIG. 1. The dark arrows indicate the flow of air. Contaminated air inlet 10 is in fluid communication with filter assembly 20 (shown in FIG. 1) via the first plenum chamber 15. Filter assembly 20 comprises filter member 21 which is in fluid communication with blower assembly 25 via second plenum chamber 22. The contaminated air enters the filter member 21 via filter inlet 21a and filtered-air leaves the filter member 21 via filter outlet 21b. Upon leaving the filter member 21, the filtered-air passes through second plenum chamber 22 and enters blower assembly 25 via duct 23 which is attached to the blower assembly inlet (not shown). The filtered air exits blower assembly 25 via filtered-air outlet 30. Filtered-air outlet 30 is in fluid communication with filtered-air passageway 35, filtered-air passageway 35 is in fluid communication with face shield assembly 40 (not shown).

Contaminated air inlet 10 may be a simple orifice or series of orifices or it may be a more complex apparatus such as, for example, it may contain a pre-filter or screen to reduce the flow of particulates into the PAPR. Examples of pre-filters include, for example, fibrous webs, meshes, foams, nonwoven fabrics and the like. The pre-filters may be removable so that they can be removed and cleaned or replaced. Examples of suitable screens include, for example, metal or plastic grids which may be permanently affixed to the inlet or may be removable.

The first plenum chamber 15 is designed so as to maximize the area of contact of the contaminated air with the filter member 21. The first plenum chamber 15 may have a variety of different shapes, but in some embodiments the first plenum chamber 15 comprises a tapered configuration being wider near the contaminated-air inlet 10.

Filter assembly 20 includes filter member 21. Filter member 21 can include a housing for the filter member, or the filter member may be a stand alone member. Filter member 21 can be constructed from a variety of materials and can target a variety of substances. For example, filter member 21 can include a traditional filter bed, a pleated medium, or any other type of filtering medium or combination of media. The filter medium can include a particulate filtering medium, a chemical filtering medium, or any combination of the two. A chemical filtering medium may include one or more of a sorbent, a catalyst or a chemically reactive medium and may target gases such as ammonia, methylamine, formaldehyde, chlorine, hydrogen chloride, sulfur dioxide, acidic gases, organic vapors or any other desired gas or contaminant. The contaminated air enters the filter member 21 via filter inlet 21a and filtered-air leaves the filter member 21 via filter outlet 21b. Filter inlet 21a and filter outlet 21b may simply comprise surfaces of filter member 21, or they may be orifices in the housing for the filter member, if filter member 21 is contained within a housing. The filter member 21 typically has dimensions of width, length, and depth such that a maximum surface area is in fluid communication with the first and second plenum chambers 15 and 22.

In some embodiments, it may be desirable that the filter member 21 be a replaceable filter cartridge. These filter cartridges typically comprise a housing and at least one type of filtering media, often more than one type. In these embodiments, filter inlet 21a and filter outlet 21b are portions of the filter cartridge housing. In some embodiments, the filter cartridge is curved (as shown in FIG. 2). Curvature of the filter cartridge can aid the overall helmet to better fit upon the human head. Additionally, many currently produced curved filter cartridges may be able to be used without modification in the PAPR 100. When curved filter cartridges are used they typically are oriented such that a convex surface of the filter cartridge is in fluid communication with the first or contaminated-air plenum chamber 15. While not wishing to be bound by theory, it is believed that this configuration maximizes the filter surface area in fluid contact with the contaminated air. Use of replaceable filter cartridges can allow the cartridges to be quickly and easily replaced by a new filter cartridge.

The second plenum chamber 22 is in fluid communication with filter member 21 and also with blower assembly 25. The second plenum chamber 22 is designed so as to maximize the area of contact of the filtered air with the filter member 21. The second plenum chamber 22 may have a variety of different shapes, but in some embodiments the second plenum chamber 22 comprises a tapered configuration being wider near the duct 23 that is in fluid communication with the inlet blower assembly 25.

Blower assembly 25 is in fluid communication with plenum chamber 22 via duct 23. The filtered air enters the blower assembly via an inlet (not shown) and exits the blower assembly 25 via filtered-air outlet 30. The blower assembly typically comprises a blower fan and a motor. The blower motor drives the blower fan which causes the air to flow through the PAPR. Typically the blower motor is a DC motor. Typically, the power source for the blower motor comprises batteries, either rechargeable or non-rechargeable. One exemplary radial blower suitable for use in some embodiments of the present disclosure is described, for example, in the co-pending patent application attorney docket number 66172US002, incorporated herein by reference.

The filtered air exits blower assembly 25 via filtered-air outlet 30. Filtered-air outlet 30 is in fluid communication with face shield assembly 40 via filtered-air passageway 35. Filtered-air passageway 35 may be a channel, a plurality of channels, a duct, or it may simply be an orifice leading to the inside portion of the helmet.

Also disclosed are methods of making PAPRs. In some embodiments, the method comprises providing a helmet and attaching the filtering assembly within the helmet to form the PAPR. The filtering assembly may be a self-contained unit which may be attached to the helmet to form the PAPR, or the helmet may contain structures which are part of the filtering assembly, making the helmet and filtering assembly a composite respirator assembly. For example, as described above, the filtered air passageway 35 may be duct attached to the self-contained filtering assembly or it may be channel or plurality of channels built into the helmet. It may also simply be a space in the helmet between the inside surface of the helmet and the user's head. Similarly, the two plenum chambers 15 and 22 may be included in the self-contained filtering assembly, or one or both of the plenum chambers may be built into the helmet structure.

What is claimed is:

1. A powered air respirator comprising:
a helmet and a filtering assembly within the helmet;
a face shield assembly adapted to be positioned in the front of the helmet and in fluid communication with the filtering assembly by a filtered-air passageway; wherein the filtering assembly comprises:
a blower assembly including a filtered-air outlet and an inlet, the filtered-air outlet being in fluid communication with the filtered-air passageway;
a filtered-air plenum chamber in fluid communication with the inlet of
the blower assembly;
a filter member adjacent to, and in fluid communication with the filtered-air plenum chamber; and
a contaminated-air plenum chamber adjacent to, and in fluid communication with the filter member and in fluid communication with
a contaminated-air inlet.

2. The powered air respirator of claim 1, wherein the filtered-air plenum chamber comprises a tapered configuration that is wider near the air intake port of the blower assembly.

3. The powered air respirator of claim 1, wherein the contaminated-air plenum chamber comprises a tapered configuration that is wider near the contaminated-air inlet.

4. The powered air respirator of claim 1, wherein the filtered-air plenum chamber comprises a tapered configuration that is wider near the air intake port of the blower assembly and wherein the contaminated-air plenum chamber comprises a tapered configuration that is wider near the contaminated-air inlet.

5. The powered air respirator of claim 1, wherein the helmet comprises an inner surface, and portions of the inner surface of the helmet forms portions of the filtered-air and contaminated-air plenum chambers.

6. The powered air respirator of claim 1, wherein the filtering assembly comprises a self-contained unit that is removable from the helmet.

7. The powered air respirator of claim 1, wherein the helmet and the filtering assembly together form a composite respirator assembly.

8. The powered air respirator of claim 1, wherein the filter member comprises a removable filter cartridge.

9. The powered air respirator of claim 1, wherein the filter member comprises a filter web.

10. The powered air respirator of claim 8, wherein the removable filter cartridge is curved.

11. The powered air respirator of claim 8, wherein the removable filter cartridge comprises a filter cartridge housing and a filter bed.

12. The powered air respirator of claim 8, wherein the removable filter cartridge comprises a filter cartridge housing and a filter web.

13. The powered air respirator of claim 12, wherein the filter web comprises a pleated filter web.

14. The powered air respirator of claim 9, wherein the curved filter cartridge has a concave surface and a convex surface, the concave surface being in fluid communication with the filtered-air plenum chamber, the convex surface being in fluid communication with the contaminated-air plenum chamber.

15. The powered air respirator of claim 1, wherein the blower assembly further comprises a motor and a fan.

16. The powered air respirator of claim 1, wherein the filtered-air passageway comprises a duct or a space between a surface of the helmet and the user's head.

17. The powered air respirator of claim 1, further comprising a pre-filter assembly attached to the contaminated-air inlet.

18. The powered air respirator of claim 17, wherein the pre-filter assembly comprises a removable filter.

19. A method of making a powered air respirator comprising:
providing a helmet;
providing a filtering assembly; and
attaching the filtering assembly within the helmet to form a powered air purifying respirator such that the air purifying respirator comprises:
a face shield assembly adapted to be positioned in the front of the helmet and in fluid communication with the filtering assembly by a filtered-air passageway; wherein the filtering assembly comprises:
a blower assembly including an filtered-air outlet and an inlet, the filtered-air outlet being in fluid communication with the filtered-air passageway;
a filtered-air plenum chamber in fluid communication with the inlet of
the blower assembly;
a filter member adjacent to, and in fluid communication with the filtered-air plenum chamber; and
a contaminated-air plenum chamber adjacent to, and in fluid communication with the filter member and in fluid communication with
a contaminated-air inlet.

20. The method of claim 19, wherein the filtering assembly comprises a self-contained unit that is removable from the helmet.

21. The method of claim 19, wherein the helmet and the filtering assembly together form a composite respirator assembly.
